(19) United States
(12) Patent Application Publication
(10) Pub. No.: US 2007/0239809 A1
(43) Pub. Date: Oct. 11, 2007

(54) Method for calculating a local extremum, preferably a local minimum, of a multidimensional function E(x1, x2, ..., xn)

(76) Inventors: Michael Moseler, Buchenbach (DE); Peter Gumbsch, Gundelfingen (DE); Erik Bitzek, Karlsruhe (DE); Pekka Koskinnen, Freiburg (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/398,681

(22) Filed: Apr. 6, 2006

(51) Int. Cl. G06F 7/00; G06F 15/00

(52) U.S. Cl. 708/207

(57) ABSTRACT

The invention relates to a Method for calculating a local extremum, preferably a local minimum, of a multidimensional function E(x₁, x₂, . . . , xₙ) which is interpretable as a function of potential energy with spatial coordinates (x₁, x₂, . . . , xₙ), using an iteration process based on a molecular dynamics based quenching method comprising the following steps:

a) Calculating a trajectory X(ti) at discrete times tᵢ=Σᵢδtᵢ starting from an assigned initial coordinate X(0) on basis of a gradient fₖ=δE/δxₖ with k=1, . . . ,n and a time derivatives of the coordinates vₖ=dxₖ/dt using fₓₖ=mₓₖ dvₓₖ/dt in which mₓₖ represent masses at the spatial coordinates and vₓₖ=dxₖ/dt represents velocity

b) Performing a molecular dynamics based quenching method for analysing said function E(x₁, x₂, . . . , xₙ) of existence of a local extremum, in case of reaching a local extremum abort processing and/or select a new initial coordinate and proceed further from step a)

c) Calculating at each iteration time step δtᵢ
F=(fₓₖ) and (k=1, . . . ,n) representing a global force vector field acting in the spatial coordinates,
V=(vₓₖ) representing a velocity vector field, P=F·V representing power Setting V=(1−α)×V+α×(F/|F|)·|V|
α is a dimensionless variable and amounts a given initial value αₛₜₐᵣₜ at first iteration time step
In case of P<0: V is set to zero, α becomes αₛₜₐᵣₜ, δtᵢ will be reduced and return to step b)
In case of P≧0: Analysing whether the number of conducted iteration steps since the last detected case of P<0 exceeds a given minimum number Nₘᵢₙ, in case of “no” returning to step b) and in case of “yes” increasing δtᵢ, decreasing α and return to step b).

### TECHNICAL FIELD

The invention concerns to a method for calculating a local extremum, preferably a local minimum, of a multidimensional function E(x₁, x₂, . . . , xₙ).

The local optimization of a multidimensional function E(x₁, x₂, . . . , xₙ) is of great importance in many technical applications. Beside of the following given examples there are many other areas where a superior optimization method is highly beneficial for its user.

In data-analysis and statistical modelling, the global optimum of a fitness function X²(α₁,α₂, . . . ,αₙ) defined on some suitable parameter-space (α₁,α₂, . . . ,αₙ) has to be found. Already for a moderate number of parameters, this requires a time consuming search. One of the limiting steps in this procedure is the finding of local minima. A fast local optimizer allows for more efficient search and therefore the likelihood of finding the global optimum is strongly increased providing a better model fit.

In molecular modelling, the structural and thermodynamic properties of molecules, clusters, nanostructures, soft- and bio-matter or periodic bulk system are determined by the potential energy E(r₁, . . . ,rₙ) as a function of the atomic coordinates r₁, . . . ,rₙ. At low temperatures, the structure and therefore the performance of these systems is determined by the optimum of the energy. Also here a fast optimisation is crucial for the development of new materials, drugs, devices etc..

In electronic structure calculations, the energy E[ψ₁, . . . ,ψₙ] as a functional of the electronic degrees of freedom ψ₁, . . . ,ψₙ has to be optimised. Examples are Hartree-Fock and the Kohn-Sham theory. This task is very time consuming and consequently only small systems can be studied. A more efficient local optimisation scheme allows for the description of larger systems as well as a significant speed up for smaller systems.

Another example is the objective function in neural networks.

### STATE OF THE ART

Existing methods for analysing and calculating such multidimensional functions use gradient information δE/δxₖ and sometimes higher order derivatives to produce a path in parameter space that drifts from some starting point X to the next local minimum of the function. Frequently used methods are steepest descent, Newton-Raphson, quasi-Newton, e.g. Broyden-Fletcher-Goldfarb-Shanno or Conjugate gradients as described in W.H. Press, S. A. Teukolsky, W. T. Vefterling, B. P. Flannery, Numerical Recipes in C++: the Art of Scientific Computing, Cambridge University Press, Cambridge, 2002. In many cases, the computational speed and the speed of convergence are not sufficient to find the optimum solution of the problems described in before mentioned examples under sections Technical field. These methods are designed for a good performance on parabolic multidimensional functions. They slow down drastically when confronted with highly non-parabolic functions providing elbow, serpent and maze shaped “valleys” in the functional landscape. The criterion for the local optimum is often that all gradients must be smaller than some user supplied error limit. In many applications very small error limits are required. Often this cannot be achieved by the existing schemes.

Some of the methods require the storage of the order n² numbers, where n is the dimensionality of the problem (e.g. Newton-type methods). This may be prohibitive and may prevent the optimisation of functions with a large number of parameters.

Especially in computational materials science one of the most common tasks is to find a nearest minimum potential energy for and atomic system, starting from a given configuration. For this purpose variants in using molecular dynamics (MD) for minimization purposes by removing kinetic energy from the system have been developed. The MD-based methods, among others are especially designed for atomistic systems. Furthermore, many algorithms to find the global minimum rely on these local ‘quenching’-algorithms as well. P. E. Gill, W. Murray, and M. H. Wright discuss in more detail optimization algorithms in “Practical Optimization”, Academic Press, New York, 1981 while their applications to atomistic modelling are discussed in A. R. Leach, Molecular Modelling: principles and applications, Prentice Hall, Harrlow, UK, 2001, 2nd ed. In general, there are no ‘best’ methods for quenching. The choice of the method depends on a number of factors and depends for example if the optimal structure should be determined, if the range of mechanical stability of a system under load should be tested, or whether only thermal noise should be removed from a system; and to which precision. Other factors include the computational cost of the different parts of the calculations, the availability of analytical derivatives, the robustness of the method and the size and thereby the required storage space of the system.

For example, any method that requires the storage of the Hessian matrix may experience memory problems with systems containing thousands of atoms. For simulations using computationally intensive atomistic interaction models like ab-initio calculations on the other hand the required number of iterations is the critical factor. It is therefore justified to have a wide range of different relaxation methods available, from which to choose the one most adapted to the system under study. Quenching methods based on MD have been thought to be good for practical realization, but not very competitive with ‘real’, sophisticated algorithms. For this reason MD-based quenching methods have been introduced traditionally as by-products of secondary importance in regular papers like in E. Bitzek, D. Weygand, and P. Gumbsch, in IUTAM, Symposium on Mesoscopic Dynamics of Fracture Process and Material Strength, edited by H. Kitagawa and Y. Shibutani (Kluwer Academic Publishers, Dordrecht, 2004), pp. 45-57, never receiving the attention and effort they actually deserved.

### DESCRIPTION OF THE INVENTION

It is therefore an object of the invention to provide a method for calculating a local extremum, preferably a local minimum, of a multidimensional function E(x₁, x₂, . . . , xₙ) which is interpretable as a function of potential energy with spatial coordinates (x₁, x₂, . . . , xₙ), using an iteration process based on a molecular dynamics based quenching method that enables conducting the search for local extremum faster compared to standard methods. Further the inventive method shall be more effective and robust than known comparable methods.

The solution of the object on which the present invention is based is set forth in claim 1. Features which further develop the inventive idea are the subject matter of the subordinate claims and can be drawn from the further description with reference to the preferred embodiment.

The invention represents an extremely fast and accurate method and technical realization to find the local minima of a multidimensional function. The gradients at the estimated minima can be made much smaller, i.e. many orders of magnitude, than in any other local optimisation method. After conducting a series of test runs with the inventive method FIRE, which stands for Fast Inertial Relaxation Engine and used as a synonym for the inventive method, it can be stated that the local optima was found much faster than by any other existing method. The application of FIRE in global search algorithms generally results in an essential time saving for finding the global optimum. In very large parameter spaces the optimum might not be found with other strategies at all. Therefore, FIRE can help to solve optimisation problems which have not been tractable before. Since gradients can be made very small FIRE is unlikely to get stuck on local saddle points.

According to the invention a method for calculating a local extremum, preferably a local minimum, of a multidimensional function E(x₁, x₂, . . . , xₙ) which is interpretable as a function of potential energy with spatial coordinates (x₁, x₂, . . . , xₙ), using an iteration process based on a Newtonian, i.e. inertial, molecular dynamics based quenching method comprises the following steps:

In a first step a trajectory X(tᵢ) at discrete times tᵢ=Σᵢδtᵢ will be calculated, where the δtᵢ are suitable time steps, starting from an assigned initial coordinate X(0) on basis of a gradient fₖ=−δE/δxₖ with k=1, . . . ,n which is interpreted as forces, and a time derivatives of the coordinates vₖ=dxₖ/dt using fₓₖ=mₓₖdvₓₖ/dt in which mₓₖ represent masses assigned to all degrees of freedom at the spatial coordinates and vₓₖ=dxₖ/dt represents velocity.

In combination to the first step a molecular dynamics based quenching method is performed for analysing said function E(x₁, x₂, . . . , xₙ) of existence of a local extremum. If a local extremum is detected then the process will be aborted and for the search of the global minimum a new initial coordinate is selected like in the before described first step.

Further calculations are carried out within each step of iteration which underlies th time steps δtᵢ which will be adapted to the individual convergence behaviour of the multidimensional function as described in the following:

During Newtonian dynamics towards a local minimum, whenever the search is not primarily in the direction of the gradient, one may want to reset velocities. An efficient choice is not to do this locally, but instead globally by monitoring the quantity P=F·V which represent the power, where F=(fₓₖ) and (k=1, . . . ,n) represents a global force vector acting in the spatial coordinates and V=(vₓₖ) represents a velocity vector.

If the force F and the velocity V vector point essentially in the same direction, i.e. P>0, FIRE is still on the way to the local minimum. On the other hand, if P<0, kinetic energy is transformed into potential energy and FIRE moves away from the minimum. In this case all the velocities is set to zero leading to a restart of the trajectory in the direction of the gradient and therefore towards the minimum.

On the other hand the inertia introduced by the Newtonian dynamics needs to be slightly reduced for a more efficient propagation along the gradient. This reduction is introduced in a direct modification of velocities in each time step. In this case the velocity modification represents a slight “bending”, or mixing, of the velocities into the direction of the forces in the following manner:
V=(1−α)×V+α×(F/|F|)·|V|
α is a dimensionless variable and amounts a given initial value αₛₜₐᵣₜ at first iteration time step.

The mixing reduces the effect of inertia in a way not possible to mimic just by reducing the masses as it makes the global velocity to point more in the same direction as the global force. Also, if the vectors point in very different directions, it slows the propagation down by introducing damping for the velocities, with a maximum damping in one molecular dynamics (MD) step of (1-2α). The reason why the parameter a should be a relatively small number is that the damping should not get too heavy. a shall not be much greater than 0.1.

A very important aspect of the inventive method is the introduction of an adaptive time step δtᵢ depending on the convergence behaviour of the multidimensional function.

The starting condition for FIRE is to set up initial δt₀=δtₘₐₓ/2 (i=0) and α₀=αₛₜₐᵣₜ, where δtₘₐₓ and αₛₜₐᵣₜ are parameters of the method defined more accurately below. The initial setup is actually not important as far as the initial time step δtᵢ is sufficiently small.

At every stage the time step for the following MD step is determined by the current power P. On one hand, if P is positive, the internal forces do work, increasing the kinetic energy and decreasing the potential energy. If there is not too much time gone since the last time P was negative (number of steps since the last negative P is smaller than the parameter Nₘᵢₙ, the system remain steadily gain inertia without changing any parameters or the time step
δtᵢ=δtᵢ₋₁

On the other hand, if the system has already gained inertia for some time (number of steps time since the last time P was negative is larger than Nₘᵢₙ and P is still positive, it is desirable to start accelerating the dynamics of the system by increasing the time step δt by a factor f_{inc}
δtᵢ=f_{inc}δtᵢ₋₁
and by increasing the effect of inertia by decreasing the mixing via multiplication of α by f_{α,dec}
αᵢ=f_{α,dec}αᵢ₋₁

This “latency” time of Nₘᵢₙ before accelerating the dynamics is critical for the stability and robustness of the algorithm. On the other hand, if P is negative, the potential energy starts to increase. In this case one does the resetting of velocities and freezes the whole system by setting V=0 as already described above. The time step is also set to half of the previous step
δtᵢ=δtᵢ₋₁/2
so that the propagation after freezing would start smoothly and would stably start to decrease the value of the function again. Also mixing is set to its starting value αₛₜₐᵣₜ, because the mixing is the most important right after freezing for a gentle forcing of the system along the gradient.

The central idea behind the adaptive time step is to accelerate the dynamics so that the system ends up having P negative as frequently as possible but in a stable way not much more frequently than every Nₘᵢₙ. Thus if the condition of negative P is not met, more inertia is given for the system by reducing the velocity mixing, since inertia is the one that drives the system against forces.

In an advanced specification of the inventive method it is often advantageous before actually starting to use the FIRE algorithm, to start optimization for a few time steps using for example the so-called micro-convergence, in which one does MD as in FIRE but by freezing individual coordinates by setting vᵢ=0 once the condition vᵢ·fᵢ<0 is met, i.e. single coordinates move against the forces. This preparation effectively removes local disturbances, which could be quite easily done also by many other similar optimization methods. However, for the relaxation of the whole system using this kind of local approach becomes inefficient soon due to the fact it takes a lot of time for the local disturbances far apart, i.e. not strongly connected directly, but via many other parameters, to interact with each other.

As indicated above shortly the method is not very sensitive to the parameters used, except that αₛₜₐᵣₜ should not be much larger than 0.1 due to too heavy damping. The most important parameter δtₘₐₓ is the only problem-dependent parameter, so that the user of the method must have, or must develop, an understanding of the artificial or real time scales involved. It should be as large as possible since the calculation time is nearly inversely proportional to it, but still small enough for the algorithm to be stable, which can be easily tested in case the testing is not computationally too expensive. The parameters shown in table 1 provide an efficient and robust optimization for most systems.

TABLE 1
Suggested set of parameters.

| | problem |
|---|---|
| δtₘₐₓ | dependent |
| Minsteps (Nₘᵢₙ) | 5 |
| f_{inc} | 1.1 |
| αₛₜₐᵣₜ | 0.1 |
| f_{dec} | 0.99 |

Masses mₖₓ should be chosen such that the velocities for all the parameters have the same scale in the given unit system. If the parameters have been renormalized to have the same scale of variation in the given unit system, the masses can be chosen to be nearly equal. For example in atomistic systems all the atoms are preferred to have the same mass, e.g. one atomic mass unit.

### BRIEF DESCRIPTION OF THE INVENTION

The present invention is made more apparent by way of example in the following without the intention of limiting the overall inventive idea using preferred embodiments with reference to the accompanying drawings:

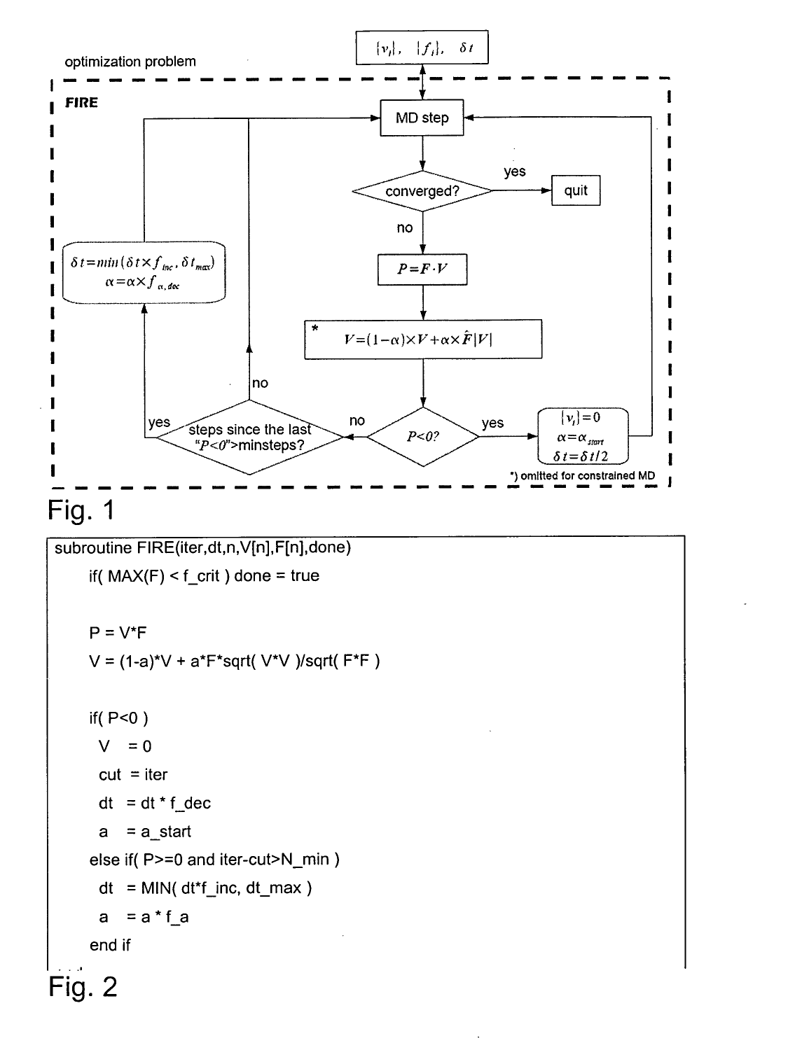

FIG. 1 shows a flowchart of the inventive method FIRE,

FIG. 2 shows a pseudo-code implementation of FIRE

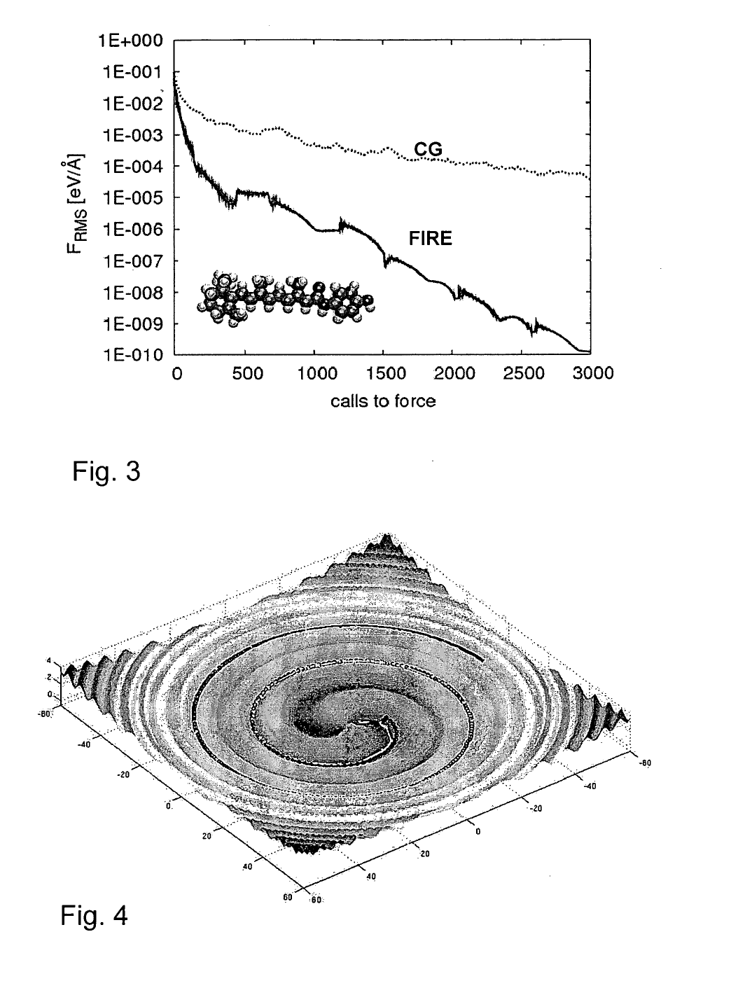

FIG. 3 shows a diagram showing effectiveness of FIRE compared to a standard CG algorithm and

FIG. 4 graphic showing an optimization of a two-dimensional model potential energy function.

### WAYS TO CARRY OUT THE INVENTION, COMMERCIAL APPLICABILITY

FIG. 1 shows a flow chart including all important calculation steps of the inventive method FIRE which realizes a rapid local optimisation of multidimensional functions based on an artificial Newtonian dynamics with convergence acceleration by velocity modifications.

From a important point of view a scheme for an adaptive time step was developed, which gives significant improvement to any previously introduced MD-based quenching algorithms. The inventive algorithm (FIRE) simply consists of an iteration of the following steps:

First assigning the initial values vᵢ, fᵢ and δtᵢ and calculate a first trajectory using the before described Newton's equations of motion f′ₓₖ=mₓₖ dvₓₖ/dt for applying the MD-based quenching algorithms (MD step) in which a discrete time step δtᵢ is given. As a result of the MD step one can detect if a extremum is found or not. In case of “yes” the process can be quit, in case of “no” following calculation steps are carried out:

1. Calculate F and V an in connection with that P=F·V

2. Set V=(1−α)·V+α·[F/|F|]·|V|

3. If the number of steps since the last minimum is larger then Nₘᵢₙ, increase the time step δtᵢ=min(δtᵢ·finc, δtₘₐₓ) and decrease mixing α=α·f_{α}.

4. If P≦0, decrease time step δtᵢ=δtᵢ·f_{dec}, freeze the system: V=0 and set a back to the starting value αₛₜₐᵣₜ.

5. Propagate atoms using any common MD integrator.

The motivation and the idea for the algorithm are as follows. For speedup it is desirable to have as large time step δtᵢ as possible for all situations. This is realized by starting with a suffciently small δtᵢ increasing it after a short ‘latency’ time of Nₘᵢₙ, during which the system gains inertia. After this δtᵢ is consecutively increased via multiplications by factor slightly larger than one (f_{inc}) up to some stability point δtₘₐₓ.

The latency time before accelerating the dynamics of the system is crucial for the stability and robustness of the algorithm. If the potential energy minimum along the current direction of motion was encountered, the system is freezed and the time step is substantially reduced by f_{dec}, to give a stable start for the next acceleration period. An explicit velocity modification, or ‘mixing’, is introduced in the second step, where the global velocity vector is slightly bent more parallel the global force vector. For α=1 one would essentially get steepest descent. But for small a the bending is weak and, essentially, the motion is damped if F and V point in different directions. The mixing is important only in the acceleration phase and is thus reduced to give the system more inertia if the condition P<0 is not met. The global nature of the algorithm assumes that all the degrees of freedom are comparable and they should have the same velocity scale. Despite the number of parameters introduced above, most of them are not directly linked to the physics of the system. Like for the five parameters in the standard conjugated gradient implementation their choice is guided by experience. For all the systems under study, the following set of parameters, used also in the examples, yielded a fast and robust behaviour: Nₘᵢₙ=5, f_{inc}=1.1, f_{dec}=0.5, αₛₜₐᵣₜ=0.1, f_{α}=0.99.

See also the pseudo-code implementation of FIRE in FIG. 2.

The maximum time step δtₘₐₓ is the most important adjustable parameter of the method. From a typical MD simulation time step δt_{MD}, normally chosen to sample about 30 times the period of the highest vibration mode of the system, one can obtain an experience-guided estimate of δtₘₐₓ=10·δt_{MD}.

FIG. 3 shows the optimization of the cancer medicine fenretinide with FIRE and CG (Fletcher-Reeves conjugated gradient). For FIRE all the masses were set to one a.m.u., maximum time step was δtₘₐₓ=1 fs and the initial time step 0.8 fs. The system is allowed to relax to unnecessarily small force norm, but it shows that the optimization with FIRE never reaches saturation, but goes steadily to smaller values on a logarithmic scale, whereas CG slows down. The initial condition for the molecule was slightly bent and twisted chain compared to the optimized structure. This is particularly challenging, since the work for the straightening and unwinding of the chain has to be done by single carbon-carbon bonds alone. Analysis of the trajectory shows that, indeed, due to its global nature and inertia FIRE is very in getting the chain essentially straightened, whereas for CG the straightening process appears to be crowded with line search directions that are guided by the wrong overall bent form of the chain.

Physically the efficiency of FIRE can be understood by realizing that the energy landscape can be, and usually is, relatively curved. To realize this, FIG. 4 shows the optimization of a two-dimensional model potential energy function
U(x,y)=−½ cos (x²/100+y²/100+2a tan (y/x))+(x²+y²)/2000)
which has a curved nature. In curved landscape CG, efficient in parabolic potentials, may be rather inefficient whereas a simple MD gives a smooth trajectory. While going down in potential energy, the kinetic energy which the system gains, intrinsically carries the information about the current energy scale. With the help of inertia, the system ‘knows’ the size of the barriers which can be crossed in some subspace of the energy landscape; the system does not strictly follow the gradients of all the degrees of freedom separately, but finds an efficient average path. The velocity mixing reduces the effect of the inertia to some extent and induces damping for the velocities if the optimization direction is not quite right. Especially large, weakly coupled systems as well as systems with many internal modes of vibration benefit from the adaptive time step. For demonstrating the effectiveness it has to be noted that concerning the illustrated function in FIG. 4 from the starting point the FIRE reaches the bottom of the spiral within 700 function calls, whereas CG needs 1900 calls.

In conclusion it can be presented an extremely simple adaptive global convergence algorithm for the relaxation of atomistic structures. Tests on different systems show that the algorithm can be significantly more efficient than a standard implementation of a energy minimization by Fletcher-Reeves conjugate gradients. Their robustness, simplicity and lock of many parameters recommend FIRE as versatile alternative to standard relaxation methods. FIRE was even applied for other general multidimensional minimization problems, where it was found mostly more efficient than previously used common algorithms.

1. Method for calculating a local extremum, preferably a local minimum, of a multidimensional function E(x₁, x₂, . . . , xₙ) which is interpretable as a function of potential energy with spatial coordinates (x₁, x₂, . . . , xₙ), using an iteration process based on a molecular dynamics based quenching method comprising the following steps:
a) Calculating a trajectory X(ti) at discrete times tᵢΣᵢδtᵢ starting from an assigned initial coordinate X(0) on basis of a gradient fₖ=−δE/δxₖ with k=1, . . . ,n and a time derivatives of the coordinates vₖ=dxₖ/dt using fₓₖ=mₓₖ dvₓₖ/dt in which mₓₖ represent masses at the spatial coordinates and vₓₖ=dxₖ/dt represents velocity
b) Performing a molecular dynamics based quenching method for analysing said function E(x₁, x₂, . . . . , xₙ) of existence of a local extremum, in case of reaching a local extremum abort processing and/or select a new initial coordinate and proceed further from step a)
c) Calculating at each iteration time step δtᵢ
F=(fₓₖ) and (k=1, . . . ,n) representing a global force vector field acting in the spatial coordinates,
V=(vₓₖ) representing a velocity vector field,
P=F·V representing power
Setting V=(1−α)×V+α×(F/|F|)·|V|

α is a dimensionless variable and amounts a given initial value αₛₜₐᵣₜ at first iteration time step
In case of P<0: V is set to zero, a becomes αₛₜₐᵣₜ, δtᵢ will be reduced and return to step b)
In case of P≧0 : Analysing whether the number of conducted iteration steps since the last detected case of P<0 exceeds a given minimum number Nₘᵢₙ, in case of “no” returning to step b) and in case of “yes” increasing δtᵢ, decreasing a and return to step b).

2. Method according to claim 1,
wherein said time step δtᵢ is initially chosen smaller than a δtₘₐₓ depending on the kind of the multidimensional function E(x₁, x₂, . . . , xₙ).

3. Method according to claim 1,
wherein said reducing of δtᵢ in case of P<0 is achieved by halving δtᵢ for a following step of iteration in the following manner: δtᵢ=δtᵢ₋₁/2

4. Method according to claim 1,
wherein said increasing of δtᵢ in case of P≧0 for using in a following iteration step is achieved by a factor f_{inc} in the following manner: δtᵢ=f_{inc}δtᵢ₋₁.

5. Method according to claim 4,
wherein for f_{inc} the value of 1,1 is chosen.

6. Method according to claims 1,
wherein said decreasing of a in case of P≧0 for using in a following iteration step is achieved by a multiplication factor f_{α,dec} in the following manner: αᵢ=f_{α,dec} αᵢ₋₁.

7. Method according to claim 6,
wherein for f_{α,dec} the value 0.99 is chosen.

8. Method according to claim 1,
wherein for αₛₜₐᵣₜ the value 0,1 is chosen.

9. Method according to claim 1,
wherein for Nₘᵢₙ the value of 5 is chosen.

10. Method according to claim 1,
wherein before calculating the trajectory X(ti) a few steps of molecular dynamics based quenching method is applied on the multidimensional function E(x₁, x₂, . . . , xₙ) in which vₓₖ will set to zero in case of vₓₖ·fₓₖ<0.

11. Method according to claim 1 for using in data-analysis and statistical modelling in which global optimum of fitness function is calculable.

12. Method according to claim 1 for using in molecular modelling in which structural and thermodynamic properties of molecules, clusters, nanostructures, soft- and bio-matter or periodic bulk systems are analysable.

13. Method according to claim 1 for using in electronic systems in which electron wavefunctions are calculable.
